(19) United States
(12) Patent Application Publication
(10) Pub. No.: US 2010/0151268 A1
(43) Pub. Date: Jun. 17, 2010

(54) Wear-resistant hard surfacing method and article

(75) Inventor: Dwayne R. Schantz, Coopersburg, PA (US)

Correspondence Address: Daniel DeJoseph;FLSmidth Inc., 2040 Avenue "C", Bethlehem, PA, 18017, US

(73) Assignee: FLSmidth A/S

(21) Appl. No.: 12/316,295

(22) Filed: Dec. 11, 2008

(51) Int. Cl. B32B 3/12; B23K 31/02; B32B 15/01

(52) U.S. Cl. 428/594; 228/178; 428/198

(57) ABSTRACT

Disclosed is a method of producing a wear resistant layer on a substantially planar metal surface which is directly impacted in a comminution process, such as the impact surface of a grinding roller. A plurality of spaced apart wear plates are applied to the metal surface. The wear plates are anchored to the metal surface by a metallic welding material that forms a weld bond with the metal surface and a mechanical bond with the wear plates.

### BACKGROUND OF THE INVENTION

The invention relates to hard metal surfaces directly impacted in a comminution processes, such as the surface of grinding rollers used in equipment for pressure comminuting of granular materials. According to the invention, there is adhered directly on such a surface, without use of indentations or the like in the surface, closely spaced separate wear plates, i.e. islands, creating a hard surface. The wear plates are made from a highly abrasion resistant material having a wear resistance greater than the metal surface. Normally the material of construction of the wear plate and the metal surface are sufficiently different that a common weld material will not function to form a strong bond (as by for example diffusion bonding) with both the metal substrate and the wear plate. The wear resistant plates are positioned on the hard metal surface a short distance from each other and secured (anchored) to the metal surface with a welding alloy that also fills at least some of the space between any two adjacent plates. The welding material forms a strong bond with the metal surface and also is positioned relative the wear plates to mechanically anchor the wear plates and to thereby form a unique wear resistant article. The wear resistant article may be utilized for example on grinding press rollers, vertical mill grinding rollers, grinding tables and similar articles.

One of the most common problems associated with wear resistant surfaces comprising a metal substrate having inlaid (or otherwise mounted on the surface thereof), wear resistant inserts, e.g. wear plates, is the difficulty, if not impossibility, for a user, for example the operator of a roller mill, to repair a damaged wear resistance surface. Moreover, common methods of manufacturing such surfaces, such as providing bores or other holding indentations in the metal substrate are costly. Other methods require the use of high temperature high-pressure processes that are also costly and require the use of specialized equipment. Wear resistance surfaces made, for example, by weld deposition can potentially be repaired in the field. However because of the restriction on the alloys that can be used for the surfacing, their wear resistance and their applied thickness are quite low, when compared with plate or insert techniques of adding highly wear resistant material to the surface.

Various techniques for hard surfacing metal substrates include for example those taught in the following U.S. Pat. Nos. 5,704,561; 5,755,033; 5,902,685 and 6,523,767 B1.

The process of U.S. Pat. No. 5,755,033 eliminates the need for providing a mechanism for securing, e.g. indentations and or bores, the wear resistant material in the substrate surface. However, the process is costly because it requires the use of specialized composite materials and an isotatic pressing process to form the wear resistant surface. Moreover, because of the composites used to make the wear resistant surface, damage to the roll is not easily repaired. Also the material used for the spaces and that for the wear resistant areas needs to be composed of materials that have a diffusion characteristic so that they can be bound together in the process.

In the case of wear resistant roll presses it is also a desirable characteristic that the wear resistant surface has a profile that enables the drawing of the material to be crushed into the rollers. The present invention permits the formation of such profiles when utilized on roll presses.

The present invention provides for a relatively inexpensive method for manufacturing an article having a wear resistant surface. Repairing a damaged surface is also relatively easy.

### SUMMARY OF THE INVENTION

The aforementioned problems can be improved by anchoring a plurality of wear resistant plates by forming a weld bond, herein defined as forming a bond by welding, flood welding, weld cladding, diffusion bonding, brazing or similar technique, with an alloy and the metal surface. The bonding material also fills at least a portion of each valley, e.g. spaces, created by the individual wear plates (islands) and is positioned to anchor the plates in place by physical versus any substantial diffusion forces. As applied to twin roller presses the welding material should settle at a level that is slightly less than the surface of the islands to provide a surface profile that is suitable for pulling material to be comminuted into the nip of the rollers. This profile can be formed at the time of manufacture or may be provided through use of the article based on the difference in wear resistance of the wear plates and the weld to bond and fill the spaces between the plates.

Each wear plate covers only a small portion of the total surface area of the metal surface, but in combination the total surface area covered by all the wear plates on the article to be treated can range from about 70% to about 90% percent by area based on the total surface area of the metal surface.

The wear plate can be made of any common wear resistant material that has superior wear properties to the metal surface it is covering and because of the unique characteristics of the invention can be of a wider variety than here-to-for used. The wear plates have essentially any substantially planar shape. They can be flat or have a curvature to fit, for example, the curvature of a press roll. They can be composed of, for example, any hard abrasive wear resistant material made from casting, forging, sintering or similar processes. They can be made of metal or ceramic materials or a combination thereof.

When used in a press roll, the wear plates preferably range in thickness from about 1 to about 10 centimeters.

The wear plates are anchored directly to the surface of an article being wear treated such as a roll used in a comminution process or to a metal liner that is arranged to the surface of such an article. Liners are used at times as they have the advantage of being potentially harder and more brittle than the underlying substrate material which requires ductility and weldability. A liner can be used to reduce the amount of material scrapped and replaced. For example, liners are commonly used on press roller equipment.

The invention will be explained particularly with respect to forming wear resistant surfaces on grinding rollers used in roller mills. In these mills a granular brittle grinding stock, e.g. cement clinkers and the like, is drawn into the nip formed by two rotating seated, oppositely rotating rollers separated from one another and is crushed between the rolls during rotation thereof. These equipment and the processes are well known in the art and are described for example in U.S. Pat. No. 5,755,033, the teachings of which are specifically incorporated herein by reference.

### BRIEF DESCRIPTION OF THE DRAWINGS

FIG. 1 illustrates one embodiment of manufacturing a press roll, showing the application of the wear resistant plates using a welding technique.

FIG. 2 shows an axonometric view of a press roller after having wear plates anchored directly to the surface of the metal roller. The numbered parts are the same as depicted in FIG. 1.

FIG. 3 is front section of the roller of FIG. 2 with one wear plate shown in an exploded view wherein the wear plate is provided in a truncated shape to provide better anchoring to the metal surface.

FIG. 4 is a planar view of a variety of wear plate configurations that can be used in the practice of the invention.

FIG. 4A is a view taken along lines A-A in FIG. 4 showing a variety of vertical cross sectional configurations that can be used in the practice of the invention.

FIG. 5 illustrates a side section of the body of FIG. 1 using essentially flat wear plates.

FIG. 6 illustrates another side section of the roll body of FIG. 1 wherein the wear plates are curved and the curve thereof substantially matches the curve of the body.

FIG. 7 illustrates another embodiment of the invention wherein the wear plates are anchored both on the upper curved surface of the roll press body as well as on a portion of the side of the press roll press body.

FIG. 8 illustrates another design of a wear plate for use in the invention.

### DETAILED DESCRIPTION OF THE INVENTION

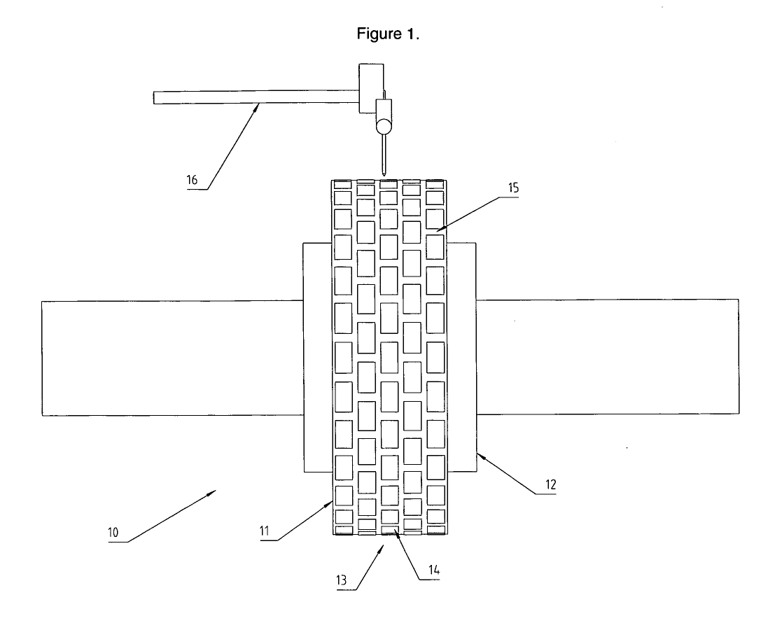

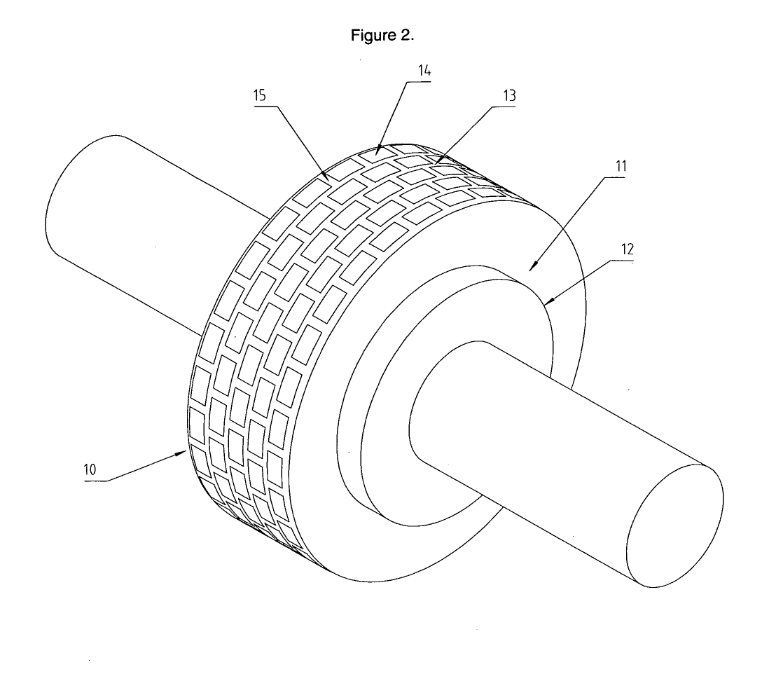

Using FIG. 1 as an illustration of one embodiment of the invention there is provided a press roll 10. The press roll comprises a cylindrical basic roll body 11 which has provided thereon at both sides coaxially arranged journals 12. A wear resistant surface 13 is formed by anchoring multiple wear plates 14 on the circumference of the surface of the basic roll body 11. The wear plates (islands) 14 have a wear resistance greater than the surface of the basic roll body 11 and are anchored to the roll body surface by the action of a welding material 15 that anchors the wear plates to the roll body and fills the spaces 15 between the wear plates.

The metal substrate of such a press roller is usually made from forged alloy steel or the like.

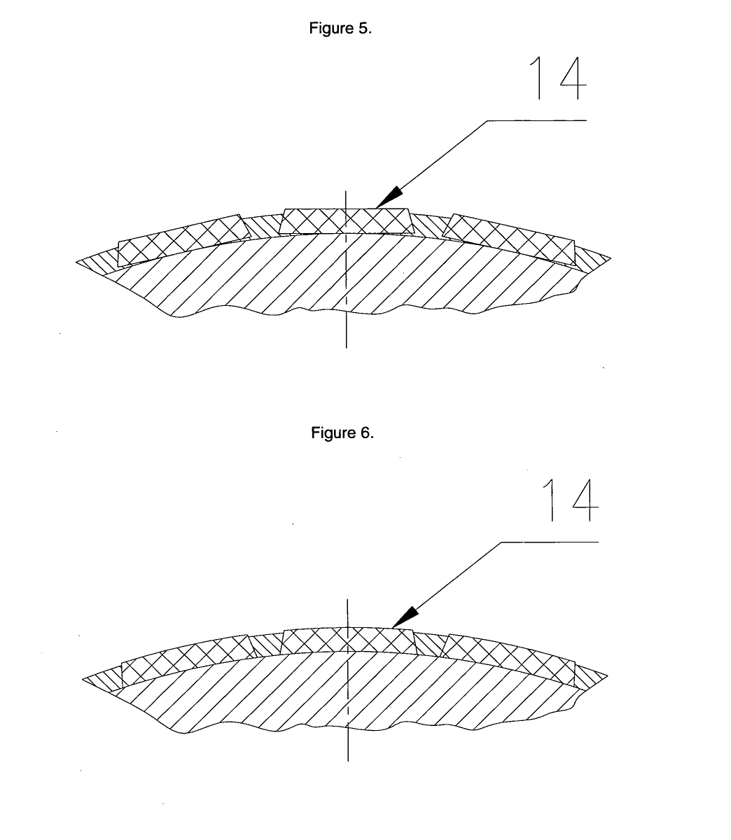

The interlocking patchwork pattern the wear resistant plates 14 form comprises alternating areas of wear plates and metal surfaces with at least a portion of said metal surfaces having some weld material thereon and which is positioned to physically interact with the wear plates and serves to physically anchor the wear plates to the metal surface. The shape of the wear plates, the relative size of the wear plates to the adjacent metal surfaces and the pattern formed by the combination of wear plates and adjacent metal surfaces can be varied in any convenient manner such as illustrated for example in FIGS. 1 and 4. FIG. 4A depicts vertical cross-sectional shapes of the plates shown in FIG. 4, with the shapes of the plates as depicted in FIGS. 4 and 4A being exemplary only. When used on a curved article such as a press roller, as the length of the wear plate increases relative to the diameter of the article being treated there will come a point that it is more advantageous that the segments adopt the curvature of the article being treated. Typically, however, the length of the segments will be sufficiently small relative to the diameter of the article being treated that such individual wear plates can be essentially flat without effecting the quality of the wear resistant surface. Obviously, curved wear plates can be used in such instances based on the preference of the practitioner of the invention. In FIGS. 5 and 6 are shown embodiments of the use of flat (FIG. 5) and curved (FIG. 6) wear pieces on rolls having essentially the same diameter. As indicated, larger wear plates are preferably curved, at least on their underside, to match more closely the curvature of the surface of the roll.

The wear plates are made of a hard abrasion resistant material that has a wear resistance greater than the metal substrate they are attached to. They can be made by casting, forging, sintering or any similar process. The material of construction of the wear plates can be hard metal, ceramic or combination of such materials. The wear resistance of the wear plates, and the extent of usage of the plates, can be varied across the width of the roller to adjust for the operational differences in wear across the surface. For example, wear on typical press roller surfaces is usually greater in at the center of the roll and less at the edges of the roll. Wear plates having a different abrasion resistance can be used along the roll width to even out the wear profile and maintain a more consistent diameter which will improve grinding efficiency. Specific materials that can be used for manufacturing the wear plates include for example metals and/or cermets containing titanium carbides, tungsten carbides and/or chromium carbides; hard metal materials and similar materials having wear resistant properties greater than the metal surface of the article being treated. The process provides for a novel article that has all the benefits of a wear resistant surface produced by other known process but in addition damaged or worn wear plates can be easily repaired in the field.

The plates are anchored to the metal surface of the comminution device e.g. a body of a press roll, by a matrix of weld material that is applied at least to some of the metal surface. Preferably none of the weld material is applied to the wear surfaces of the individual wear plates. The weld materials are made of an alloy that will bond with the metal surface of the article being treated such as by diffusion bonding and will solidify after being applied. Various means of applying the weld material can be used. For example, welding processes known in the art, such as weld spraying, metal spraying, diffusion bonding, powder metal spraying, thermal spraying, arc spraying, plasma spraying, HVOF, flame spraying, flood welding and the like can be used.

HVOF is a thermal spray process called High-Velocity Oxygen Fuel thermal spray. In the process a mix of fuel, such as Hydrogen (H2), with Oxygen (O2) is combusted and is accelerated through a nozzle to supersonic velocity up to approximately 7200 feet per second. Powder coating source material (for example, tungsten-carbide particles applied in a matrix of cobalt or cobalt and chromium) is injected into the flame. The particles are accelerated to a supersonic velocity (approximately 3300-3900 feet per second) to the substrate.

The plate is anchored through mechanical means formed upon the cooling of the welding material while the welding material forms a tight bond with the metal substrate.

One preferred method of welding is known in the art as “flood welding.” This is schematically illustrated in FIG. 1. Wear plates made of, for example, cemented titanium carbide are temporarily attached to the outer circumference of press roll body such as by using an adhesive such as silicone. In this regard, the adhesive should only contact the metal surface directly beneath the underside of the wear plates and not the metal surface located between wear plates on which weld material will be applied. The press roll is positioned in a horizontal position along its axis in a device allowing rotation along the axis of the shaft. A flood-welding device 16 is positioned, as shown in FIG. 1, at the apex of the roll and molten welding material is placed onto the roll and into the spaces between the adhered wear plates. The roll body and the inserts are preferably preheated to a temperature of from about 350° to about 500° C. The flood-welding device is moved back and forth across the surface of the apex of the roll to deposit the molten weld material. This can be done automatically or under the control of a human operator. The roll is rotated so that the weld area is positioned at the apex of the curved surface. A large diameter coated welding electrode or flux cored wire well known in the art can be employed. A weld metal puddle is formed and the electrode or wire is moved across the roll to fill the space, e.g. cavity between the wear plates. The welding slag rolls off and freezes to create a protective shell over the hot liquid weld metal during solidification. The welding process continues across the surface of the roll and then the roll is rotated at a sufficiently slow rate that the wear plates are anchored to the surface of the roll. The roll body is slowly rotated to keep the weld position down hand and keep the liquid weld metal in the horizontal position.

Peening of the weld and wear plate surface surfaces is performed when the weld material solidifies, but is preferably at its forging temperature. Peening is the process of mechanically working a metal surface to reduce various stresses caused by welding. Shot peening, hammer peening, laser peening or the like can be employed. Peening reduces the stresses formed in the welds and reduces subsequent cracking.

Preferably a post weld heat treatment is also performed. This can be performed in a furnace or with ceramic heating blankets. The heat treatment is used to control the cooling rate to reduce stresses and to temper the weld material. The proper temperature to use will depend on the exact material used to make up the metal substrate, the wear plates and the welding alloy used to anchor the wear plates.

The shape of the wear resistant plates, as illustrated in FIG. 4, can be square, rectangular, oval, rhomboids, or other polygons. They are preferably arranged to maximize the surface area of the wear plates compared to the matrix of weld material used to anchor them securely to the metal substrate. The plates normally make up from about 70 to about 90 percent of the surface area of the wear resistant surface. The weld should be present in a sufficient amount to anchor the plates securely to the metal substrate to be protected. The size of the wear plates will depend on the size of the article being wear treated. Each of the wear plates should have an exposed surface area an area of about 6 to about 60 cm². Plates having an exposed surface area of from about 20 to about 30 cm² are preferred.

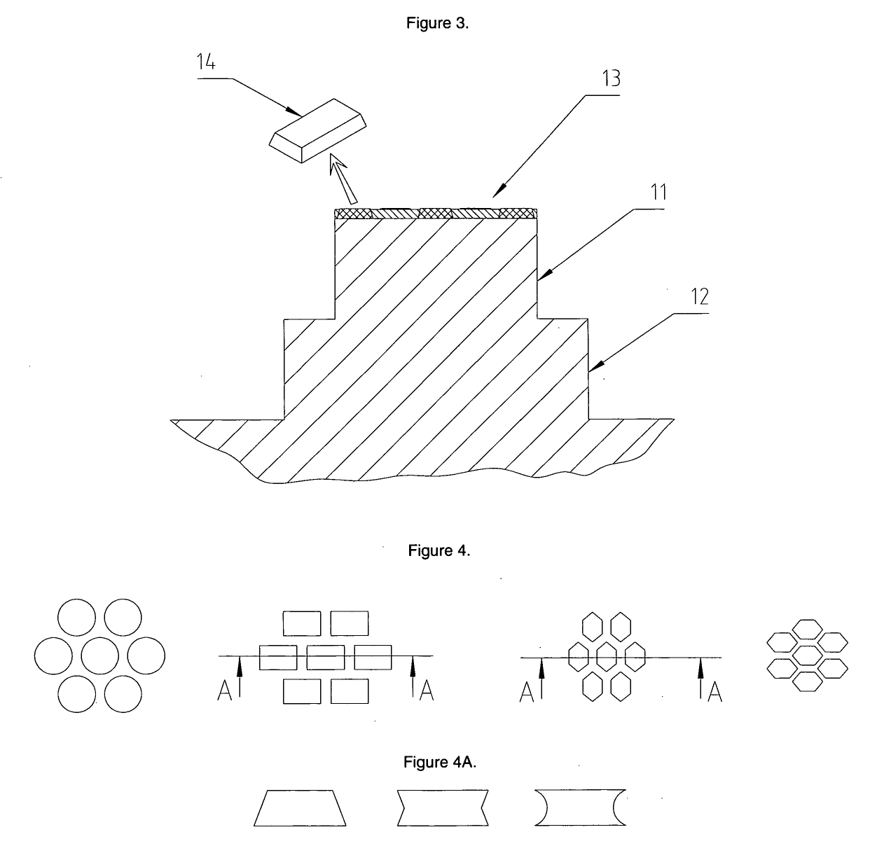

The shape of the metal wear plates from a side view should be such that a weld that bonds with the surface of the metal substrate, e.g. the surface of the body of a press roll, will mechanically hold the plates in place, typically by overlapping at least a portion of the base of the plate with solidified weld material. Typically, a suitable shape of the wear plates is where the base of the plate (i.e. that part that is adjacent to the metal substrate), has a larger horizontal cross-sectional area than at least one other cross sectional slice of the metal plate parallel to the base. For example as illustrated in FIG. 3, the wear plate 14 is a truncated pyramid. Truncated cones, truncated polygons and other similar shapes can be used. A basically concave configuration, in vertical cross-section, would also be suitable. Another example of a plate shape that be used is shown in FIG. 8. In this example the plate is formed in the shape of two concentric oval or round portions forming an upper body and lower body (base), 14a and 14b, wherein the lower body has a larger diameter than the upper body so as to form a lip. The base rests against the metal substrate and the lip provides an additional anchor for the metal plate by being covered, at least in part, by weld material that is also bonded to the metal surface.

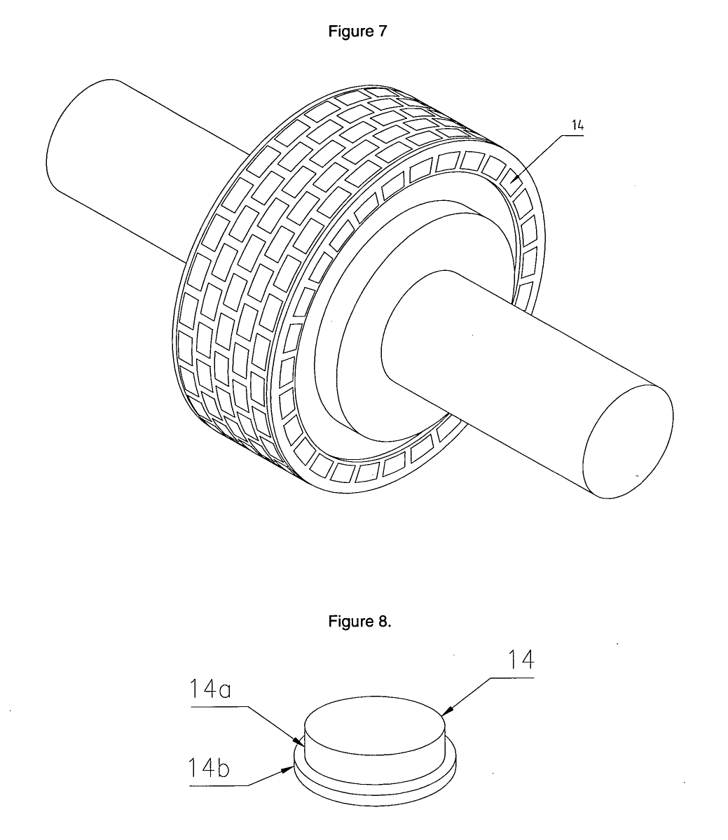

Another embodiment of a press roll is shown in FIG. 7. In this embodiment, wear plates 14 are also anchored along the side of the roller body 11 using the same process as described here-in-before to reduce wear on the side from contact with cheek plates, which are wear liners held in close proximity to the sides of the roller body 11 to restrain material leakage from the side of the crushing area. It is to be understood that the form of this invention as shown is merely a preferred embodiment.

Various changes may be made in the function and arrangement of parts; equivalent means may be substituted for those illustrated and described; and certain features may be used independently from others without departing from the spirit and scope of the invention as defined in the following claims.

What is claimed is:

1. A method of producing a wear resistant article comprising a wear resistant layer on a substantially planar metal surface which comprises:
a. applying to the metal surface a plurality of spaced apart wear plates composed of a material that has a wear resistance greater than the metal surface and which does not form a substantial bond with a welding material compatible to weld to the metal surface, to thereby form an alternating pattern of wear plates and metal surfaces there between, and
b. anchoring the wear plates with a molten metallic welding material, said material forming upon solidification a weld bond with said metal surface and a mechanical bond with said wear plates, thereby to attach the wear plates to the metal surface.

2. The method of claim 1 wherein the weld bond is a diffusion bond.

3. The method of claim 2 wherein the weld bond is applied by a flood welding process.

4. The method of claim 3 wherein the metal surface and the wear plates are preheated to a temperature of from about 350° to about 500° C. prior to the flood welding process.

5. The method of claim 1 wherein a post weld heat treatment is performed on the wear resistant article.

6. The method of claim 1 wherein the weld bond is applied by a high-velocity oxygen fuel thermal spray process.

7. A article suitable for use in a comminution process comprising:
a metal surface on which there is situated a plurality of spaced apart wear plates, said wear plates being comprised of a material that (i) has a wear resistance greater than the metal surface and (ii) does not form a substantial bond with a welding material compatible to weld to the metal surface;
with said wear plates covering and being anchored to a portion of the surface by a welding material that is attached by a weld bond to at least some of the surface not covered by said wear plates and a mechanical bond with said wear plates.

8. The article of claim 7 wherein the metal surface is curved, and at least some of the wear plates have a curvature that matches the curvature of the metal surface.

9. The article of claim 7 wherein the wear plates are comprised of metals or cermets containing titanium carbides, tungsten carbides and/or chromium carbides

10. The article of claim 7 wherein the wear plates have a shape selected from a truncated pyramid, a truncated cones and a truncated polygon.

11. The article of claim 7 wherein the wear plates comprise from about 70 to about 90 percent of the surface area of the metal surface.
